(19) United States
(12) Patent Application Publication
(10) Pub. No.: US 2013/0306233 A1
(43) Pub. Date: Nov. 21, 2013

(54) METHOD AND ARRANGEMENT FOR PRODUCING PREFORMS

(71) Applicants: Niccolo Pini, Zurich (CH); Daniele Rogantini, Ascona (CH); Giovanni Furia, Claro (CH)

(72) Inventors: Niccolo Pini, Zurich (CH); Daniele Rogantini, Ascona (CH); Giovanni Furia, Claro (CH)

(73) Assignee: KRINGLAN COMPOSITES AG, Otelfingen (CH)

(21) Appl. No.: 13/982,592

(22) PCT Filed: Jan. 24, 2012
(86) PCT No.: PCT/EP2012/051041

§ 371 Date: Jul. 30, 2013

(30) Foreign Application Priority Data
Jan. 31, 2011 (CH) 165/11

(51) Int. Cl. B32B 38/00

(52) U.S. Cl. CPC B32B 38/0004
USPC 156/256; 156/354

(57) ABSTRACT

In a method for producing fiber-reinforced preforms with a thermoplastic matrix, first individual precuts (11, 25) are generated from fiber-reinforced semi-finished products such as films, panels, webs or ribbons, said precuts are transferred by means of automated transport means (13, 27) onto a storage area and then joined by means of spot welding to form preforms.

The present invention relates to a method for producing fiber-reinforced preforms with a thermoplastic matrix according to the preamble of claim 1, as well as an arrangement for the automatic production of fiber-reinforced preforms.

The production of so-called preforms of fiber-composite workpieces with thermoplastic matrices is known per se. First, individual precuts with the correct form and fiber orientation are cut from semi-finished products such as for example fiber-reinforced films, ribbons or panels etc. and these precuts are then manually positioned exactly onto corresponding tools and finally joined by means of small welding spots.

These known and manually performed methods for producing preforms are very time-consuming and hardly acceptable for serial production. R is also important to achieve a high precision in the reproducibility of the geometric position of the fiber-reinforced precuts on the preforming tools in the different positions.

It is thus a task of the present invention to accelerate the execution of the described method.

Accordingly, a method is proposed for producing preforms according to the wording of claim 1.

R is proposed that, first, individual precuts be generated from fiber-reinforced semi finished products such as films, ribbons or panels etc. and that these precuts be transferred by means of automated transport means onto a storage area such as a preforming tool and then joined to one another by means of spot welding to form preforms.

According to one embodiment, it is proposed that precuts be generated in a predefined form and fiber direction, from fiber-reinforced semi-finished products such as films, panels, webs or ribbons etc., that these precuts be placed and positioned in an approximately exact position to one another on a preforming tool by means of at least one automated transport means and that the deposited precuts be joined to one another by means of spot welding.

The production of the precuts is achieved by means of so-called cutters, by stamping, by means of cutting blades etc. and according to one embodiment it is proposed that the automated transport means be one or several robots, having at least one gripping member for picking up resp. putting down again the generated precuts.

According to a further embodiment, it is possible to provide at least one intermediate storage in order to temporarily store the precuts. The intermediate storage can be for example a vertical automated carousel, wherein the precuts are stored in draw-like support plates, either on a support plate of similar precuts, or on a same support plate for all precuts, provided for the production of a preform.

The automated transport means can be for example robots, with one or more articulated arms, wherein the articulated arm of the robots has gripping elements with adjustable suction cups and possibly one or several ultrasound welding modules.

Further embodiments of the inventive method are characterized in the dependent claims.

The inventive method described is particularly suited for producing rotationally symmetrical or near rotationally symmetrical preforms such as:
oval, rectangular, hexagonal tubular forms, conical tubular forms (open or closed)
tubular forms with varying wall thickness
bolt attachments requiring a wall reinforcement
branched tubular forms
curved tubular forms
2D components such as e.g. door module, cross-members or the like
etc.

In this respect, the production of a wheel rim will be given by way of example.

Further, an arrangement is proposed for the automated production of fiber-reinforced preforms according to the wording of claim 7.

The arrangement has at least one two-dimensional cutting device for generating precuts from fiber-reinforced semi-finished products such as films, ribbons, panels, etc., and at least one automated transport means for picking up and, if applicable, putting down the precuts on a preforming tool and a preforming tool onto which the precuts can be deposited and which is designed such that after production of the preform, the tool is moldable.

Further embodiments of the inventive arrangement are characterized in dependent claims.

The invention will now be described in more detail by way of example and with reference to the attached figures, wherein:

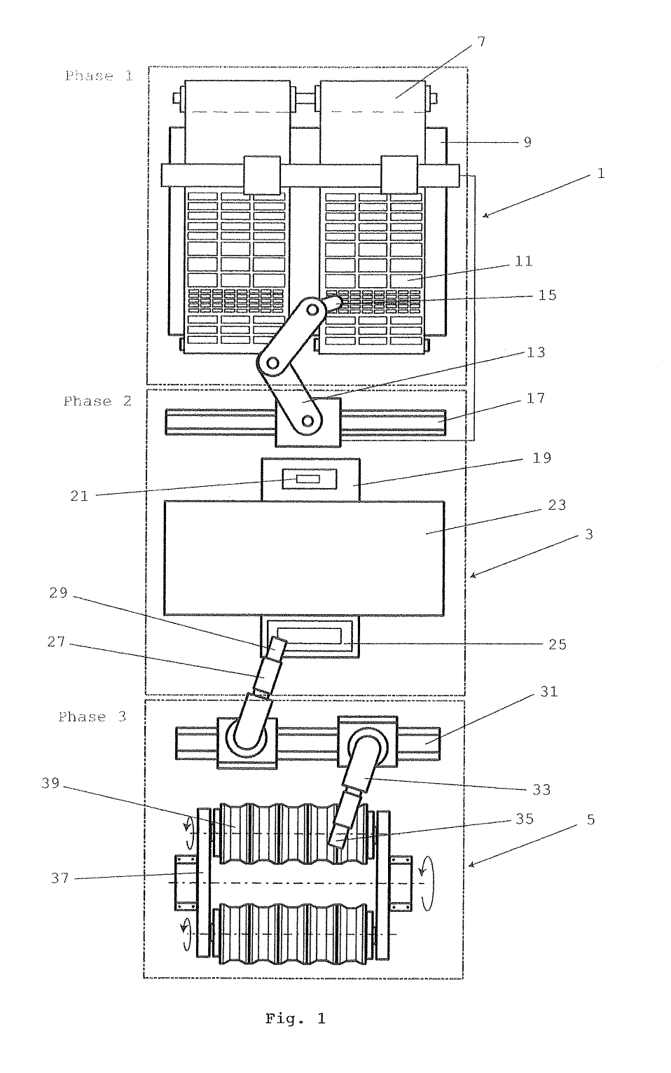

FIG. 1 shows diagrammatically a possible embodiment of the inventive method in three phases: cutting, temporary storage and displacement of the fiber-reinforced precuts,

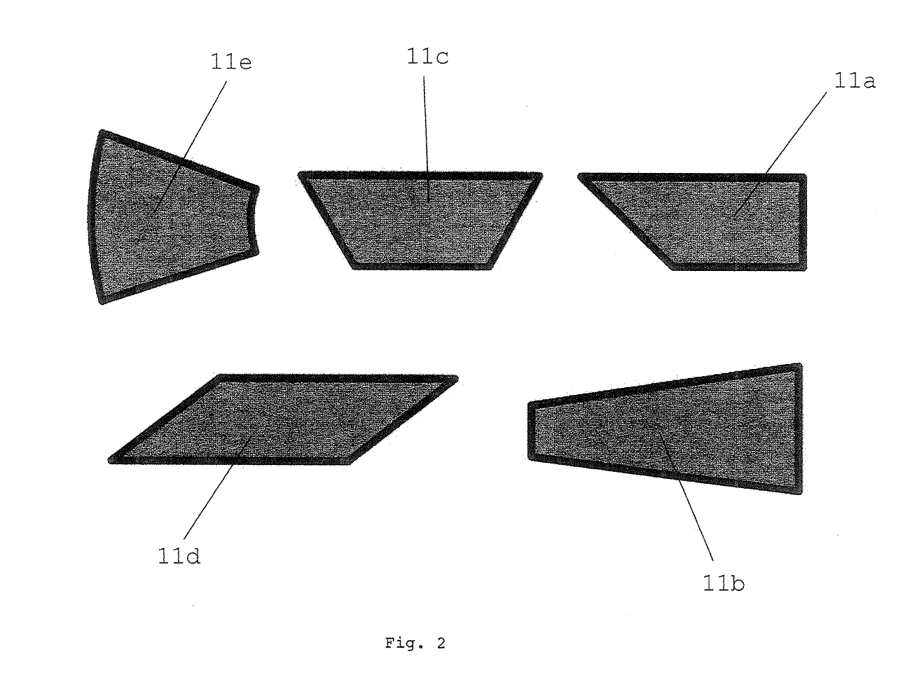

FIG. 2 shows some embodiments of fiber-reinforced precuts,

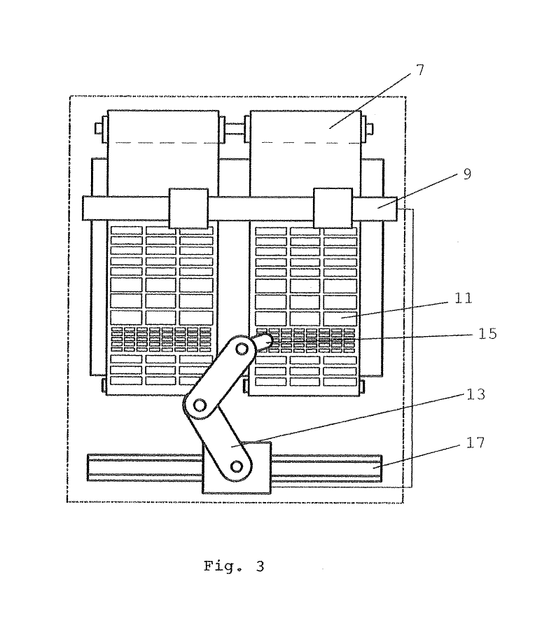

FIG. 3 shows partially from FIG. 1 the phase of cutting precuts from rolls of semi-finished material,

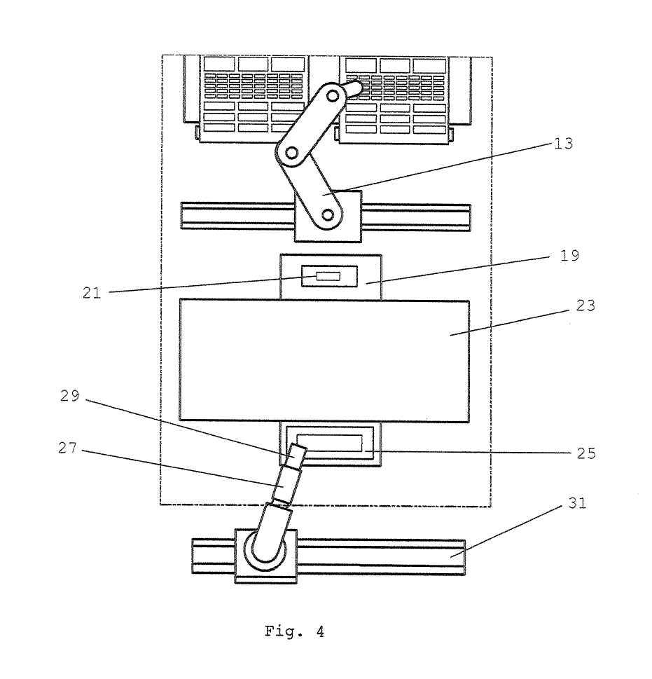

FIG. 4 shows partially from FIG. 1 and diagrammatically the transfer of the precuts to an intermediate storage and subsequently the removal of the precuts by means of a robot,

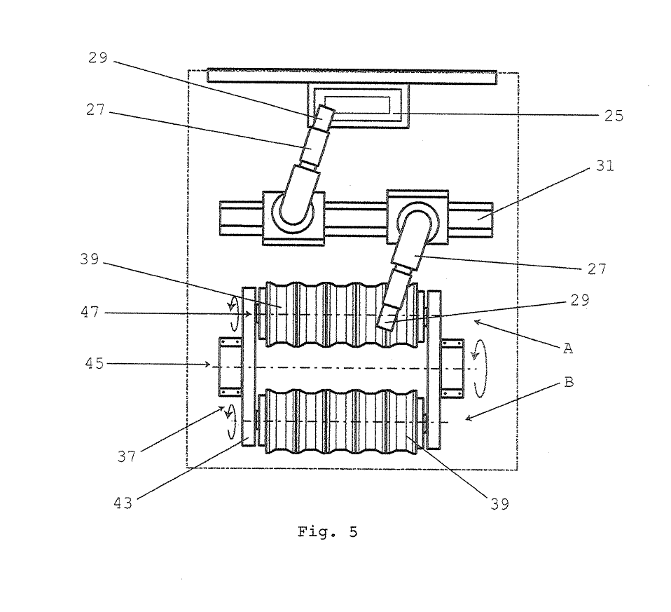

FIG. 5 shows diagrammatically and partially from FIG. 1 the transfer of the precuts from the intermediate storage to the preforming tool and the generation of the preform by means of spot welding,

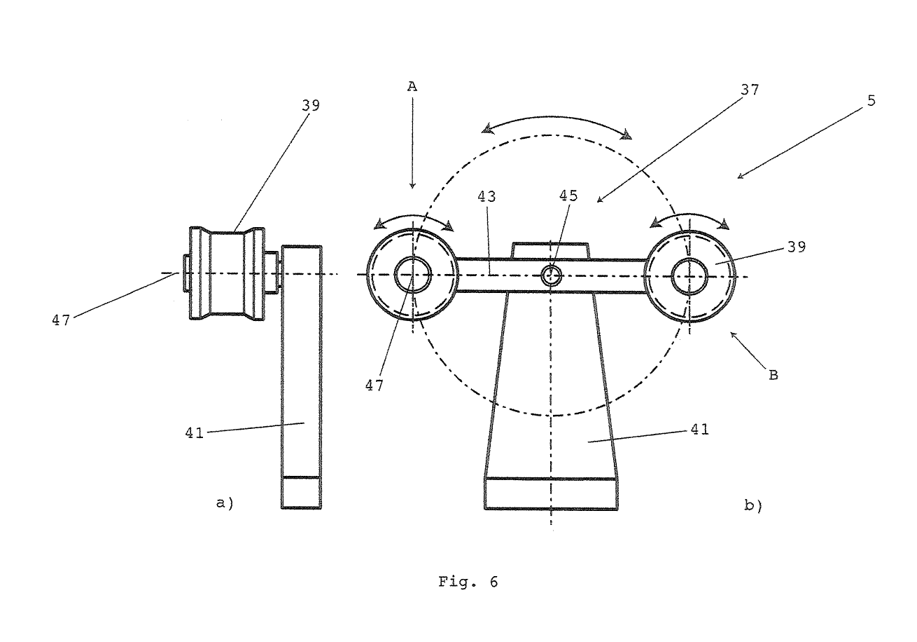

FIGS. 6a and 6b show a possible embodiment of the preforming tool in lateral view and in cross-section, on the basis of a so-called revolver rotation system,

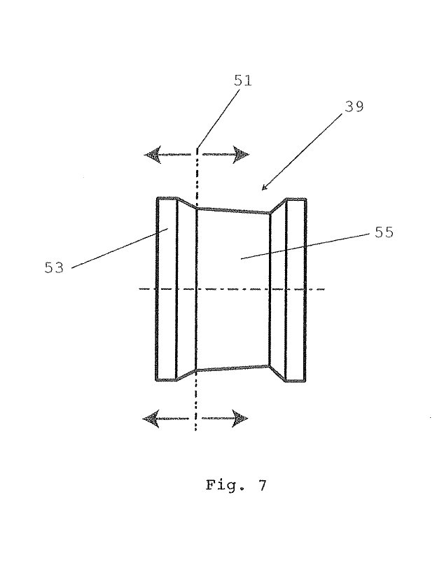

FIG. 7 shows diagrammatically in cross-section a preforming tool for generating a wheel rim preform for motor vehicles,

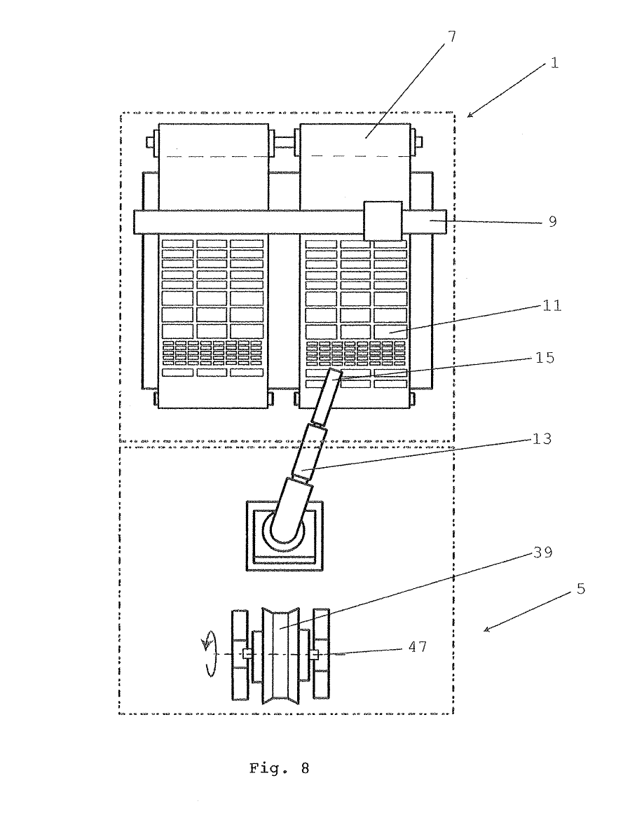

FIG. 8 shows diagrammatically a further embodiment of the inventive method without the use of an intermediate storage, and

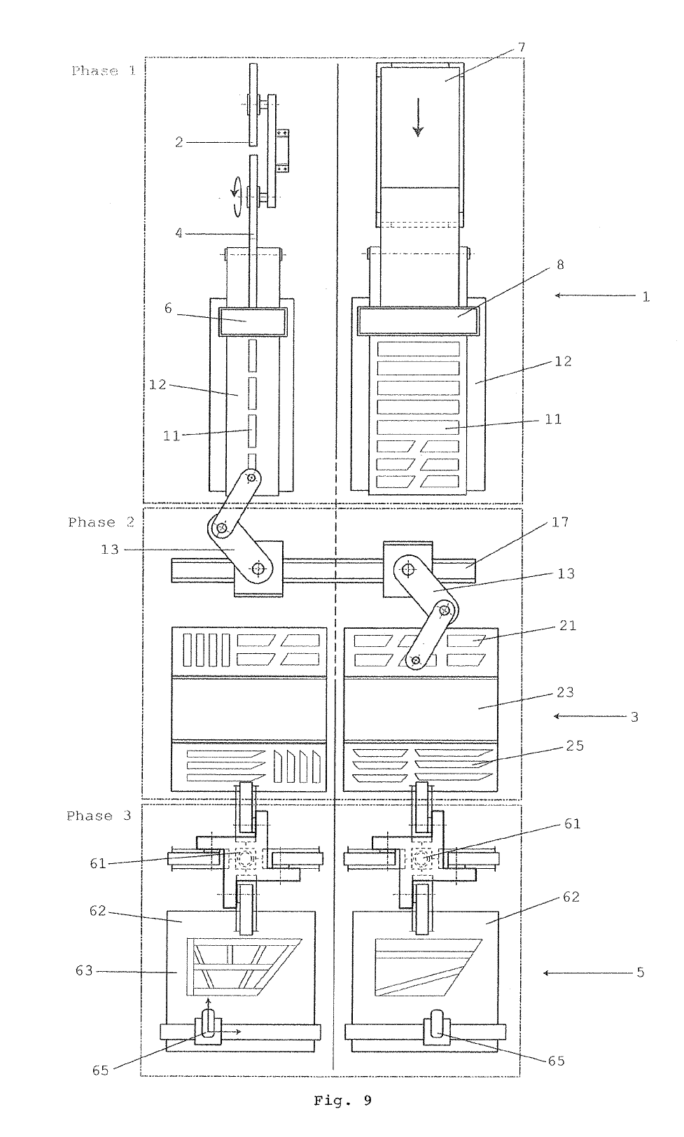

FIG. 9 shows diagrammatically again a further embodiment of the inventive method for the parallel generation of two 2-dimensional preforms.

FIG. 1 shows diagrammatically a possible embodiment of the method in three phases, namely cutting of rolls of semi-finished material, storage of fiber-reinforced precuts as well as finally the transport and welding of the preforms.

In phase I, as represented in particular also in FIG. 3, the process begins on a for example two-dimensional cutting machine (cutter) 9, where for example carbon fiber reinforced precuts (CFRP) 11 are cut out from one or several carbon fiber bands (rolls of semi-finished material) 7. In order to accelerate the process, there is a possibility to mount an additional cutting tool module onto the cutter 9. The cut CFRP are sorted with a robot 13 according to their shape and placed in an intermediate storage 23 (phase H). The choice of the robot 13 rests on the displacement requirements between the cutting machine 9 and the intermediate storage 23, which for instance suggests 2D linear movements and Z travel. Therefore, the choice has been reduced for example to two different robot models such as SCARA or portal robots. If for example the SCARA model is selected, it is mounted on a running device with a transversely placed track axis 17 in order to increase the mobility and range.

Some examples of possible precuts 11a to 11e, which can be cut out by means of the cutter resp. of the cutting machine 9 from rolls 7 of semi-finished material are represented in FIG. 2. This is only a selection and there are no limits to the possible precut shapes. It is of course also possible, by using rolls of semi-finished material with different thicknesses, to generate precuts with correspondingly different thicknesses.

Instead of rolls of semi-finished material, it is also possible to use ribbons or panels that have different thicknesses.

As previously mentioned, the CFRP are cut with the cutter 9 from rolls or panels etc. of semi-finished material, then they are moved further from the cutter with a conveyor belt until a robot 13 seizes them with a gripping element 15. The picking up resp, the pick-up coordinates are transmitted from the cutting machine directly to a robot controller.

In the second phase according to FIG. 4, the robot controller receives from a storage controller a communication of the position of the storage locations 19 in the intermediate storage, so that it can store the CFRP 21 at the desired location. The intermediate storage can be for example a vertical automated carousel (e.g. with a paternoster system). This solution provides good space utilization in the cell, where for example drawers 19 can be stacked. The different CFRP shapes 21 can be used in precut blister forms with rectangular external geometries. In this case, the storage and picking up of CFRPs is made considerably easier thanks to the same pick-up position. The intermediate storage 23 is provided with a controller in order to control the rolling movement of the drawers and the position of the CFRPs etc. For picking up the CFRP from the cutter, a gripping element 15 is provided on the robot and which is equipped for example with adjustable suction cups.

As represented diagrammatically in particular in FIG. 4, the first robot 13 stores the CFRPs 21 in the intermediate storage 23, for example in position 19. On the opposite side of the intermediate storage 23, the CFRPs are retrieved by means of a further robot 27. Represented diagrammatically, the retrievable CFRP is in the opposite position 25.

The third phase begins with one or several articulated-arm robots 27 which bring the individual CFRPs 25 from the intermediate storage to the preforming tool 39 and fasten them with the correct alignment by welding onto the tool resp. onto the underlying layers, as represented diagrammatically in FIG. 5. The robot controller learns the position of the respective CFRP 25 in the intermediate storage 23 from the storage controller. The positioning of the CFRPs preferably takes place in three dimensions and the simultaneous movement is preferably performed by a for instance six-axis robot fastened onto the linear axle 31. In this case too, gripping elements 29, which are equipped with adjustable suction cups and one or several ultrasound welding modules, are provided on both articulated-arm robots for picking up the CFRPs. The two robots 27 can work together or be independent. One possibility is for the first robot to bring the precuts onto the preforming tool, as represented diagrammatically in FIG. 5, and for the second one to weld them together, or for both robots to perform the same process individually. Here too, the robots can be mounted on a runner rail 31 in order to improve their mobility. The preforming tool 39, for example, represented in FIG. 5 and also with reference to FIG. 6, is fastened onto a rotating axle 47 so that positioning at a certain angle is possible in such a way that the fastening position of the CFRPs is arranged each time on the upper tool surface. This axle 47 is controlled as the robot's eighth axis of movement. Another variant would be to mount the preforming tool onto a further articulated-arm robot.

The preforming tool arrangement 37, for example, shown with reference to FIGS. 5 and 6 and having a so-called revolver rotation system, is divided into two; both (identical) parts consists of one or several single preforming tools 39 that can be mounted in series. While one of the sides is being processed, as represented in FIGS. 5 and 6 as position A, the other (position B) can be unloaded in order to remove the preform from the tool and then to be reloaded. The rotation of the two preform tool arrangements occurs by means of a connection element 43 that can rotate around the axis 45 and which itself is held by a stand element 41. The number of the single preforming tools used depends on the cutting strategy; if CFRPs are to be cut simultaneously for several tools for example for the production of wheel rims, several individual preforming tools are mounted together serially. FIG. 5 thus shows for example arrangements of preforming tools that each have 5 tools. In FIG. 6, this arrangement reap, the revolver rotation system is represented in figure a in a lateral view and in figure b in cross section. Turning the two preforming tool arrangements is achieved by means of the revolver rotation system 37. The whole process is completely controlled by means of control software. The cutting geometry is pre-computed for each CFRP and transmitted to the cutting machine controller. The cut position on the band is also computed and determined with optimization algorithms for maximum material utilization.

FIG. 7 shows on the basis of the example of a car wheel rim tool 39 how the tool can open a preforming tool for the purpose of preforming removal. The tool 39 is divided into two and can be separated along the dotted line 51. For the shaping of the preform, the preform tool 39 is separated along the dotted line 51 and thus both parts 53 and 55 can each be removed sideways from the preform (not represented).

FIG. 8 shows diagrammatically a further embodiment of the inventive method, exhibiting only two phases. In contrast to the representation in FIG. 1, no intermediate storage is used. Thus for example no additional cutting tool is absolutely required on the cutter. It can also be possible for only one roll 7 of semi-finished material to be used. The articulated-arm robot 13 seizes, by means of a gripping element 15 provided with suction cups and ultrasound welding head, the precuts 11 from the conveyor belt and brings them directly onto the preforming tool 39 for the welding process. The preforming tool 39 fastened onto a rotating axle 47 is positioned at a determined angle so that the mounting position of the CFRPs is on the upper tool surface. This axle 47 is controlled as the robot's seventh axis of movement.

FIG. 9 finally shows again a further embodiment of the inventive method for the production of preforms of a different nature. In the facility, represented in FIG. 9, two different preforms are produced in parallel next to one another, in the left track from so-called unidirectional ribbons 4 that are fed from rolls 2 on a revolver storage to guillotine shears 6. On the right side, glass mat reinforced thermoplastic (GMT) panels 7 are used as semi-finished product, that are cut in a punching machine 8. The further conveying occurs for both on a conveyor belt 12, wherein the precuts 11 are brought in a second phase (3) to a vertical automated carousel 23 in a manner analogous to the method described hereabove, by means for example of SCARA robots 13 arranged on a linear axis 17. In the feeding zone, precuts 21 are stored and on the opposite side precuts 25 are ready for transfer to a support plate in order to produce the final preform. In the representation according to FIG. 9, the precuts are for example either rectangular or trapezoidal. These can of course also be bent. Depending on the panel thickness or the thickness of the ribbon, the precuts have a different thickness. For example, the thicker the UD tape, the fewer precuts will be needed and thus the laying time will be reduced.

A wastage of 2.5% can also be expected for GMT panels of different size.

The precuts stored in the intermediate storage are finally stored by means of two parallel robots 61 placed side-by-side onto a preforming table 62 each, each with a welding plotter 63, wherein the welding takes finally takes place by means of a respective welding head 65. The preforming table represents the preforming tool and is executed as a plotter and takes over the function of holding and welding the precuts together (for example by ultrasound welding).

The sequence of movements and arrangements represented in FIGS. 1 to 9 are only examples that are suitable for explaining the present invention better. It is of course possible to provide one or several robots cutting precuts from one or several rolls, panels, ribbons or the like of semi-finished material, to provide several cutting elements on the cutter etc. etc. It is also possible for the intermediate storage areas, if provided, to be designed in a different manner reap, to store the temporarily stored precuts using a different organization.

One or several robots of different designs can also be provided for the arrangement of the precuts finally on one or several preforming tools, one or several tools can be provided etc. etc. The method of the invention is also in now way limited to carbon fiber reinforced materials, other reinforcement materials such as glas fibers, aramide fibers, PE fibers, basalt fibers etc. can also be used.

The ratio of fibers in the semi-finished material can be chosen at will according to the requirements. For example, the ratio can make up 30-60 volume percent. The fiber geometry can be unidirectional, be present as woven or non-woven fabric, be executed as fiber mats etc.

The choice of the matrix system such as for example the chosen thermoplastic polymer Is also based on the requirements made to the preform resp. to the component element. Examples are polypropylen, HD polyethylen, polyamide 6, 11 or 12, PET, PEEK, PES, PEI, POM, PPS, etc.

The described robots too are examples and instead for example of a six-axis articulated-arm robot, it is of course also possible to use robots that are designed differently. The same applies for the gripping members, where for example welding modules can also be arranged, with the possibility of welding simultaneously at different places.

Again, in terms of the preforming tool, the preforming tool described with reference to FIGS. 5 and 6 represents only an example. Finally, the control of the entire arrangement should be automated to the greatest extent, wherever possible, so that the individual apparatus can communicate with one another.

What is claimed is:

1. Method for producing fiber-reinforced preforms with a thermoplastic matrix, characterized in that first individual precuts are generated from fiber-reinforced semi-finished products such as films, panels, webs or ribbons, that said precuts are transferred by means of automated transport means onto a storage area and then joined by means of spot welding to form preforms.

2. Method according to claim 1, characterized in that
from the fiber-reinforced semi-finished product such as films, sheets, strips, panels or the like, precuts are generated in a predetermined shape and fiber orientation,
these are positioned on a preforming tool by means of at least one automated transport means, and
the individual stored precuts are joined together by means of small welding spots.

3. Method according to claim 1, characterized in that the precuts are generated by means of a so-called cutter, by means of punching, by means of blades, by means of cutting tools, laser cutting, water jet cutting etc. from the fiber-reinforced semi-finished product.

4. Method according to claim 1, characterized, in that the precuts are first transferred to an intermediate storage and are temporarily stored there and in that the temporarily stored precuts are then transferred onto the preforming tool.

5. Method according to claim 1, characterized in that the transfer of the precuts from the cutting device where applicable through at least one intermediate storage to the preforming tool takes place by means of at least one robot, having at least one gripping member for picking up the precut and finally for depositing the precut onto the preforming tool.

6. Method according to claim 4, characterized in that the intermediate storage is a vertical automated carousel, wherein the precuts are stored in draw-like support plates, either on a support plate of similar precuts, or on a same support plate for all precuts, provided for the production of a preform.

7. Arrangement for the automated production of so-called fiber-reinforced preforms, characterized by:
one at least two-dimensional cutting or punching device for generating precuts,
at least one automated transport means for receiving the precut and where applicable depositing it onto a preforming tool, as well as
a preforming tool on which the precuts can be deposited and which is such that after the preform has been generated, the tool can be shaped.

8. Arrangement according to claim 7, characterized in that at least one intermediate storage is provided as well as at least one robot-like transport means between cutting or punching device and intermediate storage, and at least one robot-like transport means between intermediate storage and preforming tool.

9. Arrangement according to claim 7, characterized in that the at least one transport means is a parallel, SCARA or portal robot that is controllable by a robot controller.

10. Arrangement according to claim 7, characterized in that the at least one automated transport means is a robot with at least one gripping element, with adjustable suction pads, ice grippers, needle grippers and where applicable one or several ultrasound welding modules.

11. Arrangement according to claim 7, characterized in that the at least one automated transport means is a so-called articulated-arm robot, which is mounted on a linear axle and which is at least a six-axis robot.

12. Arrangement according to claim 8, characterized in that the intermediate storage is a so-called carousel.

13. Arrangement according to claim 7, characterized in that the preform resp. preforming tools arc placed on a so-called revolver rotation system, having two positions with preforming tools, one position being provided for the displacing and welding of the precuts to form the preform and the other position being provided for unloading the finished preforms.

14. Use of the method according to claim 1 resp. of an arrangement according to one of the claims 7 to 13 for producing wheel rims for motor vehicles.
